(19) United States
(12) Patent Application Publication
(10) Pub. No.: US 2014/0016063 A1
(43) Pub. Date: Jan. 16, 2014

(54) LIGHT GUIDE PLATE, LIGHT-EMITTING UNIT AND LIQUID CRYSTAL DISPLAY DEVICE HAVING THE SAME

(71) Applicant: CHI MEI CORPORATION, Tainan City (TW)

(72) Inventors: Chih-Hung LIN, TAINAN CITY (TW); Chia-Hui YU, CHIAYI COUNTY (TW)

(21) Appl. No.: 13/934,233

(22) Filed: Jul. 3, 2013

(30) Foreign Application Priority Data
Jul. 16, 2012 (TW) 101125564

(51) Int. Cl. G02F 1/1335; F21V 8/00

(52) U.S. Cl. CPC G02F 1/133524; G02B 6/0011
USPC 349/65; 362/627; 362/611

(57) ABSTRACT

The present invention relates to a light guide plate, a light-emitting unit having the light guide plate and a liquid crystal display (LCD) device having the light-emitting unit. The light guide plate includes a pattern-forming ink composition that is coated and dried on a bottom surface of the light guide plate, so as to form dot patterns as a light guide layer. The pattern-forming ink composition includes an acrylate-based resin (A), a yellow pigment (B), a filling material (C) and a solvent (D). A LCD device including the aforementioned light guide plate can achieve the requirements of high brightness and low color temperature.

### RELATED APPLICATIONS

This application claims priority to Taiwan Application Serial Number 101125564, filed on Jul. 16, 2012, which is herein incorporated by reference.

### BACKGROUND

1. Field of Invention

The present invention relates to a light guide plate, a light-emitting unit having the light guide plate and a liquid crystal display (LCD) device having the light-emitting unit. More particularly, the present invention relates to a light guide plate providing high brightness and low color temperature, a light-emitting unit having the light guide plate and a LCD device having the light-emitting unit.

2. Description of Related Art

Liquid crystal display (LCD) devices have been widely applied in display apparatuses such as personal computers (PCs), televisions, portable phones. Since the LCD device itself is not a luminous body, it is necessarily configured with a surface light source or called as backlight for irradiating light and displaying images. In recent years, a side-type backlight, which is a surface light source and configured with a light source on the side of the light guide plate for transmitting the light through total reflection to a far side, is commonly applied in a thin LCD of lightweight and miniaturized notebook PCs, rather than a direct-type backlight where a reflective plate is configured in front of the light source.

In the above side-type backlight, since the light emitted from the light source gets much weaker through several reflections in the light guide plate. That greatly reduces the light use efficiency. Compared with the total amount of the light emitted from the light source, the use amount of the light passed through the light guide plate is limited actually. Various improvement ways for enhancing the light utilization efficiency in the light guide plate and manufacturing a LCD with high brightness are disclosed in Japanese Patent Laid-Open Publication No. H10-170724, Japanese Patent Laid-Open Publication No. 2004-327204 and Japanese Patent Laid-Open Publication No. 2008-95103. However, during operation of such LCD, there are some problem such as excessive color temperature, which causes dazzling light anduncomfortable image. Therefore, it is an important issue in the art to recognize how to reduce the color temperature and to maintain the high brightness.

Accordingly it is necessary to provide a light guide plate for improving disadvantages such as excessive color temperature, dazzling light and uncomfortable image of the conventional light guide plate.

### SUMMARY

Therefore, an aspect of the present invention provides a light guide plate. The light guide plate includes an incident light surface, a light-emitting surface and a bottom surface opposite to the light-emitting surface. A light guide layer with dot patterns is disposed on the bottom surface of the light guide plate and formed by coating and drying a pattern-forming ink composition. The pattern-forming ink composition includes an acrylate-based resin (A), a yellow pigment (B), a filling material (C) and a solvent (D).

Another aspect of the present invention provides a light-emitting unit. The light-emitting unit includes the aforementioned light guide plate and a light-emitting source laterally combined with the light guide plate.

A further aspect of the present invention provides a LCD device. The LCD device further includes the aforementioned light-emitting unit and a liquid crystal panel configured above the light-emitting surface of the light guide plate, to provide a LCD device with high brightness and low color temperature.

The structure of the light guide layer, the light guide plate, the light-emitting unit and the LCD device of the present invention and fabricating method thereof are described as follows.

### Light Guide Layer

The pattern-forming ink composition is coated and dried on the bottom surface of the light guide plate by methods of inkjet printing, screen printing, imprint or the like, so as to form dot patterns as a light guide layer.

The aforementioned pattern-forming ink composition includes the acrylate-based resin (A), the yellow pigment (B), the filling material (C) and the solvent (D), as described as follows.

### Pattern-Forming Ink Composition

The Acrylate-Based Resin (A)

The acrylate-based resin (A) used in the pattern-forming ink composition of the present invention can be, for example, polymerized by ethylenically unsaturated monomers described as follows. The specific examples of the ethylenically unsaturated monomers are: unsaturated carboxylic acids (anhydride) such as acrylic acid, methacrylic acid, butenoic acid, alpha (α)-chloroacrylic acid, ethylacrylic acid, cinnamic acid, maleic acid, maleic anhydride, fumaric acid, itaconic acid, itaconic anhydride, citraconic acid, citraconic anhydride and the like; aromatic vinyl compounds such as styrene, α-methyl styrene, vinyl toluene, p-chlorostyrene, methoxy styrene and the like; maleimides such as N-phenyl maleimide, N-o-hydroxy phenyl maleimide, N-m-hydroxy phenyl maleimide, N-p-hydroxy phenyl maleimide, N-o-methyl phenyl maleimide, N-m-methyl phenyl maleimide, N-p-methyl phenyl maleimide, N-o-methoxy phenyl maleimide, N-m-methoxy phenyl maleimide, N-p-methoxy phenyl maleimide, N-cyclohexyl maleimide and the like; unsaturated carboxylic esters such as methyl acrylate, methyl methacrylate, ethyl acrylate, ethyl methacrylate, n-propyl acrylate, n-propyl methacrylate, isopropyl acrylate, isopropyl methacrylate, N-butyl acrylate, N-butyl methacrylate, isobutyl acrylayte, isobutyl methacrylate, sec-butyl acrylate, sec-butyl methacrylate, tert-butyl acrylate, tert-butyl methacrylate, 2-hydroxyethyl acrylate, 2-hydroxyethyl methylacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tertadecyl methacrylate, cetyl methacrylate, octadecylmethacrylate, eicosyl methacrylate, docosyl methacrylate and the like; unsaturated aminoalkyl carboxylic esters such as 2-amino ethyl acrylate, 2-amino ethyl methacrylate, 2-amino propyl acrylate, 2-amino propyl methacrylate, 3-amino propyl acrylate, 3-amino propyl methacrylate and the like; unsaturated epoxypropyl carboxylic epoxypropyl esters such as epoxypropyl acrylate, epoxypropyl methacrylate and the like; vinyl carboxylic esters such as vinyl acetate, vinyl propionate, vinyl butyrate and the like; unsaturated ethers such as vinyl methyl ether, vinyl ethyl ether, allyl glycidyl ether, methylallyl glycidyl ether and the like; vinyl cyanide compounds such as acrylonitrile, methacrylonitrile, α-chloroacrylonitrile, vinylidene cyanide and the like; unsaturated amides such as acrylamide, methacrylamide, α-chloroacrylamide, N-ethoxylacrylamide, N-ethoxylmethacrylamide and the like; aliphatic conjugated diolefins such as 1,3-butadiene, isopropenylene, chloropropene and the like. The aforementioned ethylenically unsaturated monomers can be used alone or in combinations of two or more. Among those monomers, the acrylic acid, methacrylic acid, styrene, N-phenyl maleimide, methyl acrylate, methyl methacrylate, N-butyl acrylate, 2-hydroxyethyl acrylate, 2-hydroxyethyl methylacrylate, benzyl acrylate, benzyl methacrylate and the like are preferred.

The acrylate-based resin (A) of the present invention can be obtained by uniformly mixing the ethylenically unsaturated monomers through various conventional mixers or dispersers, adding 0.01 wt % to 3 wt % of polymeric initiators into the monomers and then performing polymerization under room temperature (about 10° C. to 35° C.). In the above reaction, an organic solvent can be used optionally.

Specific examples of the polymeric initiators used above are: peroxides such as benzoyl peroxide, azoic compounds such as 2,2′-azobis (isobutyronitrile) (hereinafter abbreviated as AIBN), 2,2′-azobis (methylbutyronitrile) (hereinafter abbreviated as AMBN, and the like.

Appropriate organic solvents that are chosen herein are easily to dissolve with other organic components have specific examples as follows: (poly) alkylene glycol monoalkyl ethers such as ethylene glycol monomethyl ether, ethylene glycol monoethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether and the like; other ethers such as dipropylene glycol monomethyl ether, dipropylene glycol monoethyl ether, dipropylene glycol mono-n-propyl ether, dipropylene glycol mono-n-butyl ether, tripropylene glycol monomethyl ether, tripropylene glycol monoethyl ether and the like; esters of (poly) alkylene glycol monoalkyl ether acetate such as ethylene glycol monomethyl ether acetate, ethylene glycol monoethyl ether acetate, propylene glycol monomethyl ether acetate, propylene glycol monoethyl ether acetate and the like; other ethers such as diethylene glycol dimethyl ether, diethylene glycol methyl ethyl ether, diethylene glycol diethyl ether, tetrahydrofuran and the like; ketones such as methyl ethyl ketone, cyclohexanone, 2-heptanone, 3-heptanone and the like; alkyl lactate esters such as 2-hydroxy methyl propionate, 2-hydroxy ethyl propionate (ethyl lactate) and the like; other esters such as 2-hydroxy-2-methyl methyl propionate, 2-hydroxy-2-methyl ethyl propionate, methyl 3-methoxypropionate, ethyl 3-methoxypropionate, methyl 3-ethoxypropionate, ethyl 3-ethoxypropionate, ethoxy ethyl acetate, hydroxy ethyl acetate, 2-hydroxy-3-methyl methyl butyrate, 3-methyl-3-methoxy butyl acetate, 3-methyl-3-methoxy butyl propionate, acetic ether, n-propyl acetate, isopropyl acetate, n-butyl acetate, isobutyl acetate, n-amyl acetate, isoamyl acetate, n-butyl propionate, ethyl butyrate, butyric acid n-propyl ester, isopropyl butyrate, butyric acid n-butyl ester, methyl pyruvate, ethyl pyruvate, pyruvic acid n-propyl, acetyl methyl acetate, acetyl ethyl acetate, 2-oxo ethyl butyrate and the like; aromatic or aliphatic hydrocarbons such as methylbenzene, dimethylbenzene, hexane, cyclohexane, trimethylbenzene, diisopropylbenzene and the like; carboxylic acid amines such as N-methyl pyrrolidone, N,N-dimethylformamide, N,N-dimethylacetamide. The foregoing solvents can be used alone or in combinations of two or more. Among those solvents, propylene glycol monomethyl ether, propylene glycol monomethyl ether acetate, diethylene glycol dimethyl ether, ethyl lactate, 3-ethoxy ethyl propionate are preferred.

Yellow Pigment (B)

There are no limitations specific to the yellow pigment (B) used in the pattern-forming ink composition of the present invention. Specific examples of the yellow pigment (B) are: C.I. Pigment Yellow 1, 2, 3, 4, 5, 6, 10, 12, 13 and the like (for example, trade name of Permanent Yellow 1301; made by RUIchem Co., Ltd.), 14, 15, 16, 17, 18, 20, 24, 31, 32, 34 and the like (for example, trade name of Vibfast Middle Chrome 4071; made by Vibfast Pigments Pvt., Ltd), 35, 35:1, 36, 36:1, 37, 37:1, 40, 42, 43, 53, 55, 60, 61, 62, 63, 65, 73, 74 and the like (trade name of Dalamar Yellow; made by Sigma-Aldrich Co. LLC.), 77, 81, 83, 86, 93, 94, 95, 97, 98, 100, 101, 104, 106, 108, 109, 110, 113, 114, 115, 116, 117, 118, 119, 120, 123, 125, 126, 127, 128, 129, 137, 138, 139, 144, 146, 147, 148, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 199, 213, 214 and the like.

The LCD device manufactured by such pattern-forming ink composition would have disadvantages such as excessive color temperature if the pattern-forming ink composition totally included no the yellow pigment (B).

Based on the acrylate-based resin (A) as 100 parts by weight, the usage amount of the yellow pigment (B) is usually from 0.5 to 5 parts by weight, preferably from 0.8 to 4 parts by weight, and more preferably from 1 to 3 parts by weight. When the usage amount of the yellow pigment (B) is in the aforementioned range, the LCD device manufactured by this pattern-forming ink composition has low color temperature.

Filling Material (C)

The filling material (C) of the present invention can be an organic filling material and/or an inorganic filling material, for example. Specific examples of the organic filling material are: epoxy resin, melamine resin, urea resin, acrylic resin, phenolic resin, polyimide resin, polyamide resin, polyester resin and teflon resin and the like. Specific examples of the inorganic filling material are: aluminum oxide, aluminum hydroxide, silicon dioxide (for example, commercially available products made by Catalysts And Chemicals Industries Co., Ltd.: for example, the trade names of OSCAR 1132 (the particle diameter is 12 nm; the dispersant is carbinol), OSCAR 1332 (the particle diameter is 12 nm; the dispersant is n-propanol), OSCAR 105 (the particle diameter is 60 nm; the dispersant is γ-butyrolactone), OSCAR 106 (the particle diameter is 120 nm; the dispersant is diacetone alcohol)]; the commercially available products made by Fuso Chemical Co., Ltd.: [for example, the trade names of Quartron PL-1-IPA (the particle diameter is 13 nm; the dispersant is isopropyl-ketone), Quartron PL-1-TOL (the particle diameter is 13 nm; the dispersant is methylbenzene), Quartron PL-2L-PGME (the particle diameter is 18 nm; the dispersant is propylene glycol monomethyl ether), Quartron PL-2L-MEK (the to particle diameter is 18 nm; the dispersant is methyl ethyl ketone)]; the commercially available products made by Nissan Chemical Industries, Ltd.: [for example, the trade names of IPA-ST (the particle diameter is 12 nm; the dispersant is isopropyl alcohol), EG-ST (the particle diameter is 12 nm; the dispersant is ethylene glycol), IPA-ST-L (the particle diameter is 45 nm; the dispersant is isopropyl alcohol), IPA-ST-ZL (the particle diameter is 100 nm; the dispersant is isopropyl alcohol)]); magnesium oxide, magnesium hydroxide, iron oxide, titanium dioxide, zinc oxide, stannic oxide, silicon nitride, aluminium nitride, talc [the commercially available products such as the trade name of SG-2000 (the average particle diameter is 1 μm, made by Nippon Talc Co., Ltd.)], mica, asbestos powder, quartz powder, kaolin, bentonite, diatomaceous earth, zeolite, gypsum, glass bead, glass fibre, barium sulfate, magnesium sulfate, calcium carbonate, magnesium carbonate, calcium silicate, aluminium silicate, zirconium silicate, potassium titanate and fullerene and the like. The aforementioned filling material can be used alone or in combinations of two or more.

There are no limitations specific to the average particle diameter of the filling material (C) of the present invention, usually below 10 μm, preferably below 5 μm and more preferably below 3 μm. Based on the acrylate-based resin (A) as 100 parts by weight, the usage amount of the filling material (C) is usually from 3 to 70 parts by weight, preferably from 4 to 60 parts by weight, and more preferably from 5 to 50 parts by weight.

Solvent (D)

There are no limitations specific to the kind of the solvent (D) used in the foregoing pattern-forming ink composition, which can be chosen from the solvents used in the polymerization process of the foregoing acrylate-based resin (A) and are not illustrated any more here. Furthermore, the solvent preferably is propylene glycol monomethyl ether, propylene glycol monomethyl ether acetate, diethylene glycol dimethyl ether, ethyl lactate, 3-ethoxy ethyl propionate. The solvent (D) can be used alone or in combinations of two or more.

There are no limitations specific to the usage amount of the foregoing solvent (D). Based on the acrylate-based resin (A) as 100 parts by weight, the usage amount of the solvent (D) is usually from 100 to 500 parts by weight, preferably from 150 to 450 parts by weight, and more preferably from 200 to 400 parts by weight.

Metal Oxide (E)

The metal oxide (E) of the present invention can be metal compounds such as metal oxides, metal complex salts and the like, and specific examples thereof are: metal oxides of iron, cobalt, aluminum, cadmium, lead, copper, titanium, magnesium, chromium, zinc, antimony, and the composite oxides of the foregoing metals.

The specific examples of the foregoing metal oxide (E) are: titanium dioxide particle, the commercially available products thereof are such as the trade name of NanoTek series (made by the C.I. Chemicals), OPTOLAKE series (made by Catalysts And Chemicals Industries Co., Ltd.), MT-05, MT-100W, MT-100SA, MT-100HD, MT-300HD, MT-150A, ND138, ND139, ND140, ND154, ND165, ND177 TS-063, TS-103, TS-159 (made by TAYCA), NOD-742GTF (made by NAGASE CHEMTEX) and the like; and zirconium dioxide particle, the commercial products thereof are such as a product with the trade names of HXU-110JC, HXU-120JC, HXU-210C, NZD-3101 (made by Sumitomo Osaka Cement Co., Ltd.), ID191 (made by TAYCA Co.), ZRPMA15WT %-E05 (made by C.I. Chemicals Co.), OZ-S30K (made by Nissan Chemical Industries, Ltd.). The aforementioned metal oxide (E) can be used alone or in combinations of two or more.

When the metal oxide (E) is used in the foregoing pattern-forming ink composition, the brightness of the resulted LCD device can be further enhanced.

Based on the acrylate-based resin (A) as 100 parts by weight, the usage amount of the metal oxide (E) is usually from 0.05 to 5 parts by weight, preferably from 0.08 to 4 parts by weight, and more preferably from 0.1 to 3 parts by weight.

Additive (F)

The additive (F) such as silane coupling agents, defoamers, dispersants can be selectively added into the pattern-forming ink composition of the present invention.

Specific examples of the aforementioned silane coupling agent are: vinyltrichloro silane, ethenyl triethoxysilane, vinyltris (β-methoxyethoxy) silane, β-(3,4-epoxy cyclohexyl)ethyl trimethoxy silane, 3-epoxy propoxy propyl trimethoxyl silane, γ-epoxy propoxy propyl methyl diethoxy silane, γ-methacryloxypropyltrimethoxysilane, N-(β-aminoethyl)-γ-aminopropyl trimethoxy silane, N-(β-aminoethyl)-γ-aminopropyl trimethyl dimethoxy N-phenyl-γ-aminopropyl trimethoxy silane, γ-chloropropyl trimethoxysilane, γ-sulfhydryl propyl trimethoxy silane, γ-aminopropyl trimethoxy silane, bis-1,2-(trimethoxy silane) ethane, commercially available products such as the trade name of SZ 6030 (made by Dow Corning Toray Silicone) and the trade names of KBE-903, KBE-603, KBE-403 and KBM-403 (made by Shin-Etsu Chemical Co., Ltd.).

Based on the acrylate-based resin (A) as 100 parts by weight, the content of the silane coupling agent is usually from 0 to 30 parts by weight, preferably from 3 to 25 parts by weight, and more preferably from 5 to 20 parts by weight.

Specific examples of the aforementioned defoamer are: Surfynol MD-20, Surfynol MD-30 Surfynol DF 110D, Surfynol 104E, Surfynol 420, Surfynol DF 37, Surfynol DF 58, Surfynol DF 66, Surfynol DF 70 and Surfynol DF 210 and EnviroGem AD01, EnviroGem AE01 and EnviroGem AE02 and the like (made by Air products). Based on the acrylate-based resin (A) as 100 parts by weight, the content of the defoamer is usually from 1 to 10 parts by weight, preferably from 2 to 9 parts by weight, and more preferably from 3 to 8 parts by weight.

The aforementioned dispersant can be, for example, a polymeric dispersant, a poly-ethyoxyl alkyl phosphate, a poly-ethyoxyl alkylamine, an alkanolamine, a pigment derivative and the like. Specific examples of the polymeric dispersant are: polyamidoamine (salt), polycarboxylic acid (salt), unsaturated acid esters with high molecular weight, modified polyurethanes, modified polyesters, modified poly (methyl) acrylic ester, (methyl) acrylate copolymer, naphthalenesulfonic acid formaldehyde condensate and the like. The aforementioned polymeric dispersant can be further classified into a linear-type macromolecule, a terminus modified macromolecule, a grafted macromolecule and a block-type macromolecule according to the structure.

The foregoing dispersant also can use the commercial products, and the specific examples thereof are: commercially available products with the trade names of DISPERBYK-101, DISPERBYK-107, DISPERBYK-110, DISPERBYK-130, DISPERBYK-161, DISPERBYK-162, DISPERBYK-163, DISPERBYK-164, DISPERBYK-165, DISPERBYK-166, DISPERBYK-170, BYK-P104, BYK-P105 and the like (made by BYK Chemie GmbH); commercially available products with the trade names of EFKA 4047, EFKA 4010 to 4061, EFKA 4330 to 4340, EFKA 4400 to 4402, EFKA 5010, EFKA 6220, 6745 and the like (made by EFKA—Frankl & Kirchner GmbH & Co KG); commercially available products with the trade names of AJISPERPB PB-821, AJISPERPB PB-822 and the like (made by Ajinomoto Fine—Techno Co., Inc.); commercially available products with the trade names of DISPARLON KS-860, DISPARLON KS-873N, DISPARLON 2150, DISPARLON 7004 and the like (made by Kusumoto Chemicals, Ltd.); commercially available products with the trade names of DEMOL RN, DEMOL N, DEMOL MS, DEMOL C, DEMOL SN-B, HOMOGENOL L-18, ACETAMIN 86 and the like (made by Kao Corporation); commercially available products with the trade names of SOLSPERSE 5000, SOLSPERSE 22000, SOLSPERSE 13240, SOLSPERSE 3000, SOLSPERSE 17000, SOLSPERSE 27000, SOLSPERSE 24000, SOLSPERSE 28000, SOLSPERSE 32000, SOLSPERSE 38500 and the like (made by Lubrizol Corporation), and a commercially available product with the trade name of HINOACT T-8000E (made by Kawaken Fine Chemicals Co., Ltd.).

The aforementioned additive (F) can be used alone or in combinations of two or more.

### Preparation of Pattern-Forming Ink Composition

The pattern-forming ink composition of the present invention is typically that the pattern-forming ink composition can be produced by uniformly mixing the aforementioned acrylate-based resin (A), yellow pigment (B), filling material (C) and solvent (O), optionally with addition of the metal oxide (E) and/or various additives (F), in the conventional mixer or disperser.

### Light Guide Plate

Reference is made to FIG. 1, which shows a schematic profile exploded diagram of a LCD device 100 according to an embodiment of the present invention. In an embodiment, the LCD device 100 comprises a light guide plate 110, a light-emitting unit 120 and a liquid crystal panel 150.

The aforementioned light guide plate 110 includes an incident light surface 111, an light-emitting surface 113 and a bottom surface 115 opposite to the light-emitting surface 113. The incident light surface 111 is formed at one side of the light guide plate 110, and the bottom surface 115 and the incident light surface 111 connected to each other at an oblique angle. Moreover, the thickness of the light guide plate 110 is decreased from one side of the incident light surface 111 to the other opposite side, so that the light is emitted uniformly from the light-emitting surface 113, as shown in FIG. 1.

The aforementioned dot patterns 117 are formed on the bottom surface 115 of the foregoing light guide plate 110. The aforementioned dot patterns 117 can let the incident light that passes through the incident light surface 111 to be scattered and reflected. That is to say, the light is diffused uniformly to various directions, so that there are no limitations specific to the arrangement or size of the dot patterns 117. For example, when the aforementioned dot patterns 117 are printed, various different shapes such as circles, quadrilaterals or hexagons can be formed, and the light scattering level and brightness of the dot patterns 117 also can be changed depending upon the materials used in the ink.

### Light-Emitting Unit

Reference is made to FIG. 1 again, in the abovementioned embodiment, the foregoing light-emitting unit 120 can include the aforementioned light guide plate 110 and a light-emitting source 131. The light guide plate 110 can be combined with the light-emitting source 131 laterally. The incident light surface 111 is opposite to the light-emitting source 131, so that the light (unshown) emitted from the light-emitting source 131 enters into the light guide plate 110 through the incident light surface 111, and the light is further projected towards the direction of the LCD panel 150 as directed by the light guide plate 110, as shown in FIG. 1.

The foregoing light-emitting source 131 includes a light source 133 and a reflective mask 135 configured at the outside of the light source 133. The light source 133 can be a point light source (for example, a light-emitting diode) or a line light source (for example, a long lamp). Generally, the foregoing reflective mask 135 surrounds the light source 133. However, an opening is configured at one side of the reflective mask 135 adjacent to the light guide plate 110, so that the light that is either directly emitted from the light source 133 or reflected by the reflective mask 135 enters into the light guide plate 110 through the opening of the reflective mask 135 and the incident light surface 111.

Additionally, the foregoing light-emitting unit 120 can further include an optical module 140. The optical module 140 includes multiple optical devices, such as a reflective sheet 141, a diffusion sheet 143, a prism sheet 145 and the like. The aforementioned reflective sheet 141 is adjacent to the bottom surface 115 of the light guide plate 110, so that the light radiated out of the light guide plate 110 through the bottom surface 115 is reflected through the bottom surface 115 and passes into the light guide plate 110. The aforementioned diffusion sheet 143 is adjacent to the light-emitting surface 113 of the light guide plate 110, so that the light passing through the light guide plate 110 and radiated from the light-emitting surface 113 can be diffused uniformly. The aforementioned prism sheet 145 is adjacent to the diffusion sheet 143. The prism sheet 145 can condense the light to enhance the brightness of the front surface of the liquid crystal panel 150 to which the light is projected.

### Liquid Crystal Display (LCD) Device

Reference is made to FIG. 2, which shows a schematic perspective exploded diagram of a LCD device according to an embodiment of the present invention. The LCD device 200 of the present invention at least includes a foregoing light-emitting unit 210, a liquid crystal panel 220, a top base plate 230 and a bottom base plate 240.

The aforementioned liquid crystal panel 220 can include a thin film transistor (TFT) substrate 221 (hereinafter abbreviated as a TFT substrate), a color filter (CF) substrate 223 and a liquid crystal layer (unshown) containing liquid crystal, thereby displaying an external image.

Furthermore, a printed circuit board 225 is configured with a driving chip (unshown), and connected to the TFT substrate 221 through a tape carrier package 227. Various signals required for displaying the aforementioned external image can be delivered to the TFT substrate 221 through the printed circuit board 225 and the driving chip (unshown).

Additionally, the foregoing top base plate 230 can be connected with the bottom base plate 240. An open receiving space is formed at the upper part of the above bottom base plate 240. The liquid crystal panel 220 can be supported by a part of the bottom base plate 240 around the receiving space, and the receiving space can accommodate the aforementioned light-emitting unit 210. The light provided by the aforementioned light-emitting unit 210 can pass through the liquid crystal panel 200 and the liquid crystal panel 200 displays the external image.

The aforementioned top base plate 230 covers and fixes the outer edge of the liquid crystal panel 220, so as to prevent the printed circuit board 225 from exposing to the external environment. An opening is configured in the middle region of the aforementioned top base plate 230, thereby exposing the image display region of the liquid crystal panel 220.

It is supplemented that, the present invention is illustrated by FIGS. 1 and 2 rather than being limited thereto. Therefore, the light-emitting unit of the present invention can be applied to other types of display apparatus; and it is also capable to use other types of optical devices, such as a polarized sheet or the like, in the LCD device of the present invention.

Several embodiments are described below to illustrate the application of the present invention. However, these embodiments are not used for limiting the present invention. For those skilled in the art of the present invention, various variations and modifications can be made without departing from the spirit and scope of the present invention.

### BRIEF DESCRIPTION OF THE DRAWINGS

In order to make the foregoing as well as other aspects, features, advantages, and embodiments of the present invention more apparent, the accompanying drawings are described as follows:

FIG. 1 shows a schematic profile exploded diagram of a LCD device according to an embodiment of the present invention;

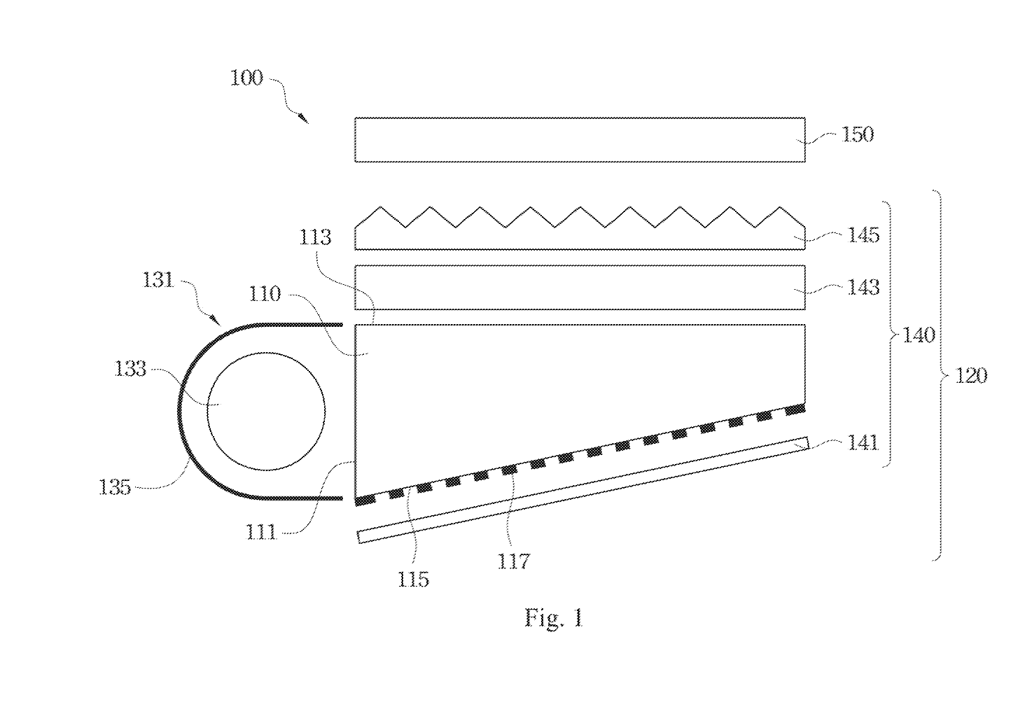

FIG. 2 shows a schematic perspective exploded diagram of a LCD device according to an embodiment of the present invention; and

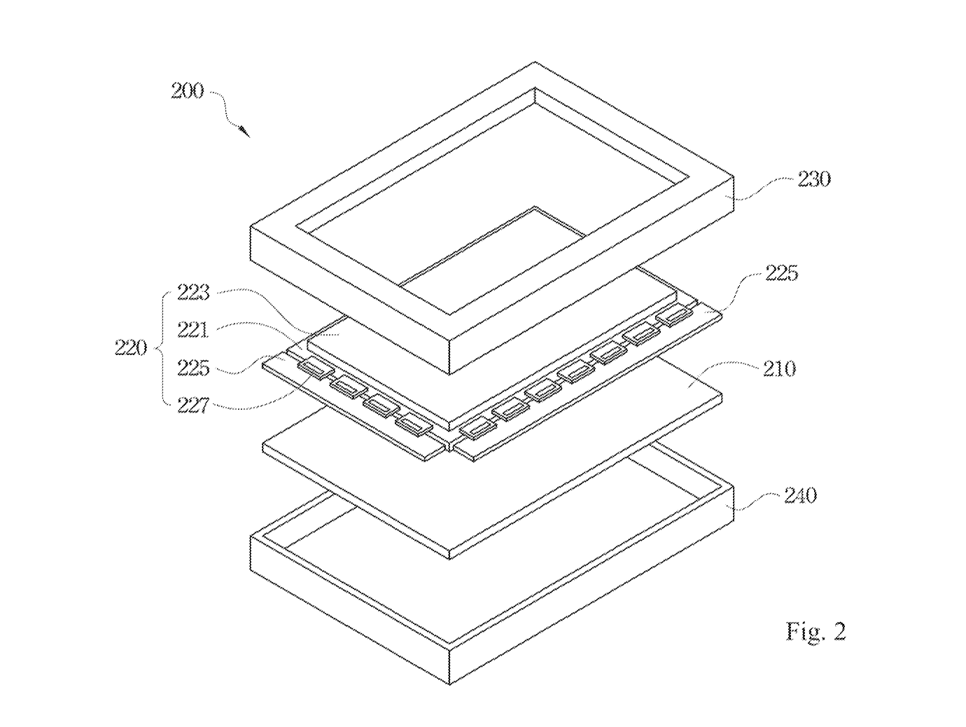

FIG. 3 shows a top view of an evaluation mode of brightness and color temperature according to an embodiment of the present invention.

### DETAILED DESCRIPTION

### Preparation of the Acrylate-Based Resin (A)

Hereinafter, the acrylate-based resins (A) of Synthesis Examples A-1 to A-6 are prepared according to Table 1 as follows.

### Synthesis Example

14 parts by weight of 2-hydroxyethyl methacrylate (hereinafter abbreviated as HEMA), 40 parts by weight of methyl methacrylate (hereinafter abbreviated as MMA), 20 parts by weight of n-butyl acrylate (hereinafter abbreviated as n-BA), 25 parts by weight of styrene (hereinafter abbreviated as SM) and 1 parts by weight of 2,2′-azobis (methylbutyronitrile) (hereinafter abbreviated as AMBN) were stirred uniformly by a planetary compulsory mixer (Model No. ARB-310; made by THINKY Corporation), followed by subjecting the reactant into a thermal polymerization reaction at 80° C. for 24 hours, thereby obtaining the acrylate-based resin (A-1).

### Synthesis Examples A-2 to A-6

Synthesis Examples A-2 to A-6 were synthesized with the same method as in Synthesis Example A-1 by using various kinds or usage amounts of the reactants for the acrylate-based resin (A). The formulations of Synthesis Examples A-1 to A-6 were listed in Table 1 rather than focusing or mentioning them in details.

TABLE 1

| | | | | | | | | Polymeric |
|---|---|---|---|---|---|---|---|---|
| Synthesis | Copolymerizable Monomer | | | | | | | Initiator |
| Examples | MAA | AA | HEMA | MMA | n-BA | BzMA | SM | AMBN |
| A-1 | | | 14 | 40 | 20 | | 25 | 1 |
| A-2 | 30 | | 4 | 25 | | | 40 | 1 |
| A-3 | 1 | | | 60 | 8 | 30 | | 1 |
| A-4 | | 5 | | 44 | | | 50 | 1 |
| A-5 | | | 10 | 35 | 50 | 4 | | 1 |
| A-6 | 2 | | 12 | | 60 | | 25 | 1 |

MAA methacrylic acid
AA acrylic acid
HEMA 2-hydroxyethyl methacrylate
MMA methyl methacrylate
n-BA n-butyl acrylate
BzMA benzyl methacrylate
SM styrene
AMBN [2,2′-azobis(methylbutyronitrile)]

Preparation of Pattern-Forming Ink Composition

The pattern-forming ink compositions of Examples 1 to 6 and Comparative Examples 1 to 3 were prepared according to Table 2 as follows.

### Example 1

100 parts by weight of the acrylate-based resin (A-1) of Synthesis Example 1, 0.3 parts by weight of yellow pigment (trade name: Permanent Yellow 1301; made by RUIchem Co., Ltd.) (B-1), 15 parts by weight of silicon dioxide (trade name: IPA-ST, made by Nissan Chemical Industries, Ltd.) (C-1) and 180 parts by weight of diethyleneglycol dimethyl ether (D-1) were stirred uniformly by the planetary compulsory mixer, followed by compounding the reactant by a three drum roller (Model No. FC-90 mm, made by Farn Chang Co., Ltd.) for 3 hours. The resulted pattern-forming ink composition was evaluated according to the following evaluation methods, and the results thereof was listed as Table 2, uniformly by a. The detection method of the brightness and color temperature were described as follows.

### Examples 2 to 6

Examples 2 to 6 were practiced with the same method as in Example 1 by using various kinds or usage amounts of the components for the pattern-forming ink composition. The formulations and detection results thereof were listed in Table 2 rather than focusing or mentioning them in details.

### Comparative examples 1 to 3

Comparative examples 1 to 3 were practiced with the same method as in Example 1 by using various kinds or usage amounts of the components for the pattern-forming ink composition. The formulations and detection results thereof were also listed in Table 2 rather than focusing or mentioning them in details.

Evaluation Methods

1. Brightness

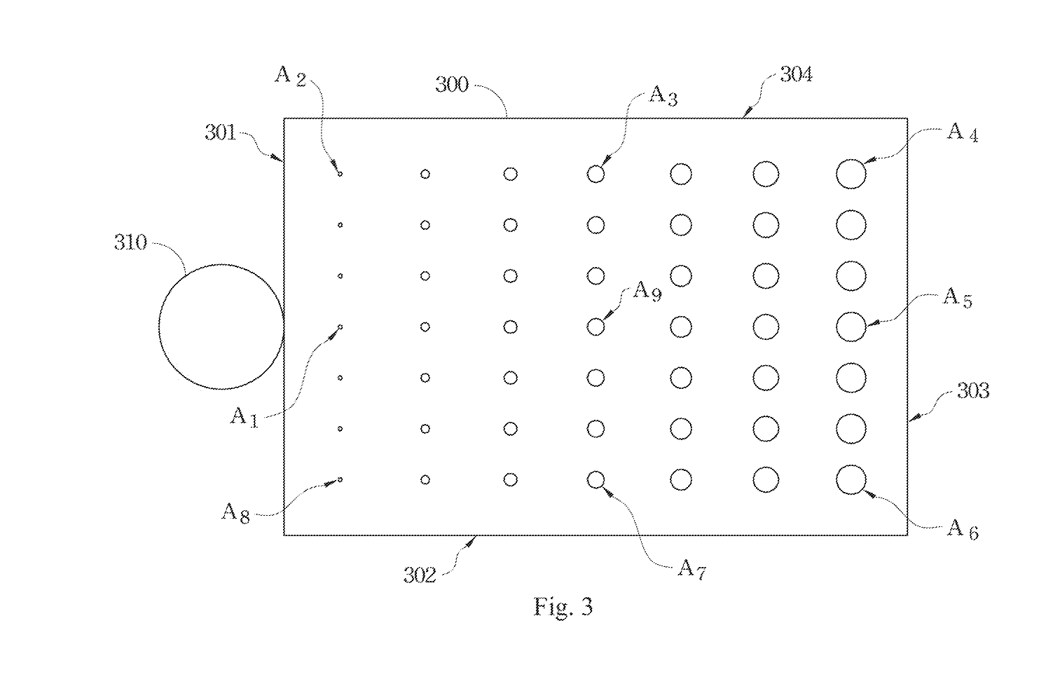

Reference is made to FIG. 3, which shows a top view of the evaluation mode of the brightness and color temperature according to an embodiment of the present invention. Firstly, the pattern-forming ink compositions of Examples 1 to 6 and Comparative Examples 1 to 3 were printed as dots with the diameters of 300 mm², 400 mm², 500 mm², 600 mm², 700 mm², 800 mm² and 900 mm² sequentially onto the light guide plate 300 (made by transparent PMMA resin; 3 mm thickness) of 32 inches from the light source end by using a screen printer (Model No. PA3-F34; made by BUILT-IN PRECISION MACHINE Co., Ltd.), as shown in FIG. 3. Next, the light guide plate printed with the pattern-forming ink composition was dried at 70° C. for 30 minutes, and then the light guide plate 300 was irradiated by a LED 9000K light source 310 for 1 hour. Afterwards, the brightness of the light guide plate 300 was measured by using a brightness photometer (Model No. BM-7A; made by Topcon Technohouse Corporation), and the measurement points (A₁ to A₉) thereof were also shown in FIG. 3. The respective distances between A₁, A₂ and A₈ and the boundary 301 of the light guide plate 300, the respective distances between A₂ to A₄ and the boundary 304 of the light guide plate 300, the respective distances between A₄ to A₆ and the boundary 303 of the light guide plate 300, and the respective distances between A₆ to A₆ the boundary 302 of the light guide plate 300 were all 20 mm. An average brightness (cd/m²) was calculated according to following Formula (I), and an evaluation was made according to the following criterion. In Formula (I), L₁ to L₉ represented the brightness of A₁ to A₉, respectively.

Average Brightness (cd/m²)=(L₁+L₂+L₃+L₄+L₅+L₆+L₇+L₈+L₉)/9 (I)
⊚: average brightness >800
◯: 800≧average brightness >700
Δ: 700≧average brightness >600
x: average brightness 600

2. Color Temperature

After the dots obtained in the foregoing detection method of “Brightness” were dried at 70° C. for 30 minutes, the light guide plate was irradiated by the LED 9000K light source for 1 hour. Then, the color temperature of the light guide plate was measured with the brightness photometer, and the distribution of the measurement points in the detection method of the “Color Temperature” was defined the same with the distribution in the detection method of “Brightness”. An average color temperature (K) was calculated according to following Formula (II), and an evaluation was made according to the following criterion. In Formula (II), T₁ to T₉ represented the color temperature of A₁ to A₉, respectively.

Average Temperature (K)=(T₁+T₂+T₃+T₄+T₅+T₆+T₇+T₈+T₉)/9 (II)
◯: average temperature <5000
Δ: 5000≦average temperature <6000
x: average temperature ≧6000

The evaluation results of the brightness and color temperature of the pattern-forming ink composition of the above Examples and Comparative Examples were shown in Table 2.

As shown in the results in Table 2, when the pattern-forming ink composition included the yellow pigment (B), the resulted light guide plate had lower color temperature. However, when the pattern-forming ink composition included the yellow pigment (B) and the metal oxide (E) simultaneously, the resulted light guide plate can had higher brightness, thereby achieving the purpose of the present invention.

### Comparative Example 4

In addition, according to embodiments of Japanese Patent Laid-Open Publication No. 2008-95103, the pattern-forming ink composition can be made by stirring 25 parts by weight of polymethyl methacrylate (about 30,000 of molecular weight), 5 parts by weight of hexamethylene diisocyanate, 40 parts by weight of acrylic beads (5 μm of average particle diameter), 10 parts by weight of dimethyl ether and 20 parts by weight of cyclohexanone were stirred uniformly by the planetary compulsory mixer and then compounded by the three drum roller for 3 hours. The resulted pattern-forming ink composition was also evaluated according to the aforementioned evaluation methods. However, the resulted color temperature from the Comparative Example 4 was evaluated as “x”.

It should be supplemented that, although specific compounds, components, specific reactive conditions, specific processes, specific evaluation methods or specific equipments are employed as exemplary embodiments of the present invention, for illustrating the light guide plate, light-emitting unit and the LCD device having the light-emitting unit of the present invention. However, as is understood by a person skilled in the art instead of limiting to the aforementioned examples, the light guide plate, light-emitting unit and the LCD device having the light-emitting unit of the present invention also can be manufactured by using other compounds, components, reactive conditions, processes, analysis methods and equipment without departing from the spirit and scope of the present invention.

As is understood by a person skilled in the art, the foregoing preferred embodiments of the present invention are illustrated of the present invention rather than limiting of the present invention. In view of the foregoing, it is intended to cover various modifications and similar arrangements included within the spirit and scope of the appended claims. Therefore, the scope of which should be accorded the broadest interpretation so as to encompass all such modifications and similar structure.

TABLE 2

| | | | | | | | | Comparative | | |
|---|---|---|---|---|---|---|---|---|---|---|
| Components | | Examples | | | | | | Examples | | |
| (parts by weight) | | 1 | 2 | 3 | 4 | 5 | 6 | 1 | 2 | 3 |
| Acrylate- | A-1 | 100 | | | | | | 100 | | |
| based | A-2 | | 100 | | | | | | | |
| resin (A) | A-3 | | | 100 | | | | | 100 | |
| | A-4 | | | | 100 | | | | | |
| | A-5 | | | | | 100 | | | | 100 |
| | A-6 | | | | | | 100 | | | |
| Yellow | B-1 | 0.3 | | | 2 | | | | | |
| pigment | B-2 | | 1 | | | 5 | | | | |
| (B) | B-3 | | | 6 | | 3 | 5 | | | |
| Filling | C-1 | 15 | | 10 | | | | 15 | 10 | |
| Material (C) | C-2 | | 1 | | | 1 | 50 | | | 1 |
| | C-3 | | | | 30 | 2 | | | | 2 |
| Solvent (D) | D-1 | 180 | | 100 | 200 | | | 180 | 1005 | |
| | D-2 | | 120 | 50 | | 180 | | | 50 | 180 |
| | D-3 | | | | | | 250 | | | |
| Metal Oxide | E-1 | | | 0.5 | | | | | 0.5 | |
| (E) | E-2 | | | | | | 1 | | | |
| Additive (F) | F-1 | | 1 | | | | | | | |
| | F-2 | | | | | 2 | | | | 2 |
| Evaluation | Brightness | ◯ | ◯ | ⊚ | ◯ | ◯ | ⊚ | ◯ | ◯ | ◯ |
| Methods | Color | ◯ | ⊚ | ◯ | ⊚ | ◯ | ⊚ | X | X | X |
| | Temp- | | | | | | | | | |
| | erature | | | | | | | | | |

B-1 C.I. Pigment Yellow 13 (trade name of Permanent Yellow 1301; made by RUIchem Co., Ltd )
B-2 C.I. Pigment Yellow 34 (trade name of Vibfast Middle Chrome 4071; made by Vibfast Pigments Pvt., Ltd)
B-3 C.I. Pigment Yellow 74 (trade name of Dalamar Yellow; made by Sigma-Aldrich Co., LLC.)
C-1 IPA-ST, silicon dioxide (average particle diameter is 12 nm, made by Nissan Chemical Industries, Ltd.)
C-2 Quartron PL-2L-PGME, silicon dioxide (18 nm of average particle diameter, made by FUSO CHEMICAL Co., Ltd.)
C-3 SG-2000, talc (1 μm of average particle diameter, made by Nippon Talc Co., Ltd.)
D-1 diethyleneglycol dimethyl ether
D-2 propyleneglycolmonomethylether
D-3 ethyl 3-ethoxypropionate
E-1 titanium dioxide (trade name of NOD-742GTF; made by NAGASE CHEMTEX Corporation)
E-2 zirconium dioxide (trade name of OZ-S30K; made by Nissan Chemical Industries, Ltd.)
F-1 KBM-403, 3-glycidoxypropyltrimethoxy silane (made by Shin-Etsu Chemical Co., Ltd.)
F-2 Disperbyk-101 (made by BYK Chemie GmbH)

What is claimed is:

1. A light guide plate, comprising:
an incident light surface of incident light;
an light-emitting surface of emergent light; and
a bottom surface opposite to the light-emitting surface, wherein the bottom surface has a light guide layer, and the light guide plate includes a pattern-forming ink composition that is coated and dried on the bottom surface of the light guide plate, so as to form dot patterns as the light guide layer, and the pattern-forming ink composition comprises:
an acrylate-based resin (A);
a yellow pigment (B);
a filling material (C); and
a solvent (D).

2. The light guide plate of claim 1, wherein based on the acrylate-based resin (A) as 100 parts by weight, the usage amount of the yellow pigment (B) is from 0.5 to 5 parts by weight, the usage amount of the filling material (C) is from 3 to 70 parts by weight, and the usage amount of the solvent (D) is 100 to 500 parts by weight.

3. The light guide plate of claim 1, wherein the pattern-forming ink composition further comprises a metal oxide (E).

4. A light-emitting unit, comprising:
a light guide plate, wherein a bottom surface of the light guide plate has a light guide layer, the light guide plate includes a pattern-forming ink composition that is coated and dried on the bottom surface of the light guide plate, so as to form dot patterns as the light guide layer, and the pattern-forming ink composition comprises:
an acrylate-based resin (A);
a yellow pigment (B);
a filling material (C); and
a solvent (D); and
a light-emitting source, wherein the light guide plate are combined with the light-emitting source laterally.

5. The light-emitting unit of claim 4, wherein based on the acrylate-based resin (A) as 100 parts by weight, the usage amount of the yellow pigment (B) is from 0.5 to 5 parts by weight, the usage amount of the filling material (C) is from 3 to 70 parts by weight, and the usage amount of the solvent (D) is 100 to 500 parts by weight.

6. The light-emitting unit of claim 4, wherein the pattern-forming ink composition further comprises a metal oxide (E).

7. A liquid crystal display (LCD) device, comprising:
a light guide plate, wherein a bottom surface of the light guide plate has a light guide layer, the light guide plate includes a pattern-forming ink composition that is coated and dried on the bottom surface of the light guide plate, so as to form dot patterns as the light guide layer, and the pattern-forming ink composition comprises:
an acrylate-based resin (A);
a yellow pigment (B);
a filling material (C); and
a solvent (D); and
a light-emitting source, wherein the light guide plate are combined with the light-emitting source laterally; and
a liquid crystal panel, wherein the liquid crystal panel is configured above an light-emitting surface of the light guide plate.

8. The LCD device of claim 7, wherein based on the acrylate-based resin (A) as 100 parts by weight, the usage amount of the yellow pigment (B) is from 0.5 to 5 parts by weight, the usage amount of the filling material (C) is from 3 to 70 parts by weight, and the usage amount of the solvent (D) is 100 to 500 parts by weight.

9. The LCD device of claim 7, wherein the pattern-forming ink composition further comprises a metal oxide (E).
